(19) United States
(12) Patent Application Publication
(10) Pub. No.: US 2002/0041085 A1
(43) Pub. Date: Apr. 11, 2002

(54) Method of impact protection for vehicle exteriors

(76) Inventor: Deborah Jean Fox, San Antonio, TX (US)

Correspondence Address: LAW OFFICES OF CHRISTOPHER L. MAKAY, 1634 Milam Building, 115 East Travis Street, San Antonio, TX, 78205, US

(21) Appl. No.: 10/003,559

(22) Filed: Oct. 24, 2001

Related U.S. Application Data
(63) Continuation of application No. 09/547,130, filed on Apr. 10, 2000.

(51) Int. Cl. B32B 3/06; B60R 21/00

(52) U.S. Cl. 280/727; 428/99

(57) ABSTRACT

In a method of impact protection for vehicle exteriors, at least one removable protective covering is stored inside a vehicle. Upon reaching a desired destination and parking the vehicle, the at least one removable protective covering is retrieved from inside the vehicle. The at least one removable protective covering is then placed on the vehicle exterior. After completion of a desired task, the at least one removable protective covering is removed from the vehicle exterior. The at least one removable protective covering is then replaced within the vehicle for later reuse.

### CROSS REFERENCE TO RELATED APPLICATION

This application is a continuation of application Ser. No. 09/547,130, which was filed Apr. 10, 2000, now abandoned.

### BACKGROUND OF THE INVENTION

1. Field of the Invention

The present invention relates to vehicle exterior protection and, more particularly, but not by way of limitation, to a method of vehicle exterior protection that utilizes a removable protective covering designed to protect against dings and dents caused by exterior impacts.

2. Description of the Related Art

It is a known fact that parking lots are perfect places for accidents. Loose shopping carts, careless pedestrians, and flying car doors all cause dents or dings on vehicle exteriors. Unfortunately, products designed specifically to prevent such accidents are limited and tend to require permanent or at least continual placement on a vehicle exterior.

One such example is the protective cover for vehicles disclosed in U.S. Pat. No. 5,158,324, which issued Oct. 27, 1992, to Flesher. Flesher discloses a custom-made car bra consisting of individual segments. Flesher specifically discloses constructing a car bra from the individual segments, which are then left in place on a continual basis. Although effective against dents or dings, the constructed car bra diminishes the aesthetic look of a vehicle's exterior due to its continual placement.

Accordingly, a method of vehicle exterior protection that utilizes a removable protective covering designed to protect against dings and dents caused by exterior impacts is highly desirable.

### SUMMARY OF THE INVENTION

In accordance with the present invention, an at least one removable protective covering includes a resilient front portion joined to a magnetic backing. The at least one removable protective covering is stored inside a vehicle. Upon reaching a desired destination and parking the vehicle, the at least one removable protective covering is retrieved from inside the vehicle. The at least one removable protective covering is then placed on the vehicle exterior. After completion of a desired task, the at least one removable protective covering is removed from the vehicle exterior. The at least one removable protective covering is then replaced within the vehicle for later reuse.

It is an object of the present invention to provide a covering that protects a vehicle exterior from dings, dents, scratches and chips caused by impacts.

It is another object of the present invention to make the covering easily removable once placed on a vehicle exterior to prevent the diminishing of the aesthetic quality of the vehicle exterior.

Still other objects, features, and advantages of the present invention will become evident to those of ordinary skill in the art in light of the following.

### BRIEF DESCRIPTION OF THE DRAWINGS

FIG. 1 is a side elevation view illustrating a removable protective covering according to the preferred embodiment.

FIG. 2 is a top plan view illustrating the removable protective covering according to the preferred embodiment.

FIG. 3 is a side elevation view illustrating the removable protective covering according to the preferred embodiment placed on a vehicle exterior.

### DETAILED DESCRIPTION OF THE PREFERRED EMBODIMENT

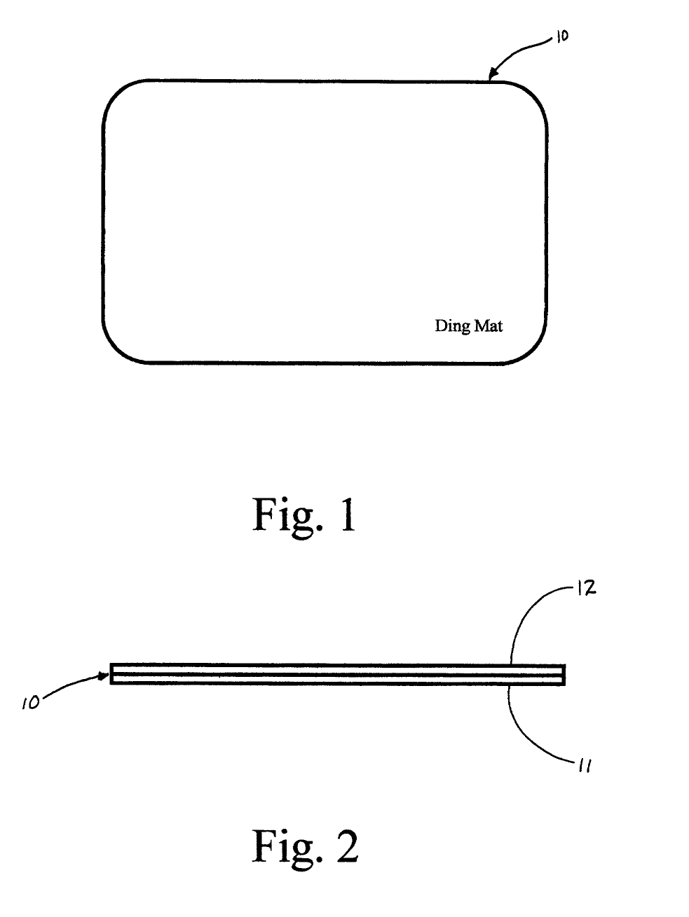

As illustrated in FIGS. 1 and 2, a removable protective covering 10 includes a resilient front portion 11 joined to a magnetic backing 12. The resilient front portion 11 preferably comprises a vinyl or plastic material with sufficient thickness to disburse a force of an impact, such as by a shopping cart or car door. The magnetic backing 12 preferably comprises a flexible flat permanent magnet. In this preferred embodiment, the vinyl or plastic material comprising the resilient front portion 11 is laminated to the flexible flat permanent magnet comprising the magnetic backing 12, although those of ordinary skill in the art will recognize other methods of joining the resilient front portion 11 to the magnetic backing 12, such as adhesives. The total thickness of the removable protective covering 10 is determined by the resiliency of the material used in the resilient front portion 11. Thus, a harder material would require less thickness to offer sufficient protection than a softer material.

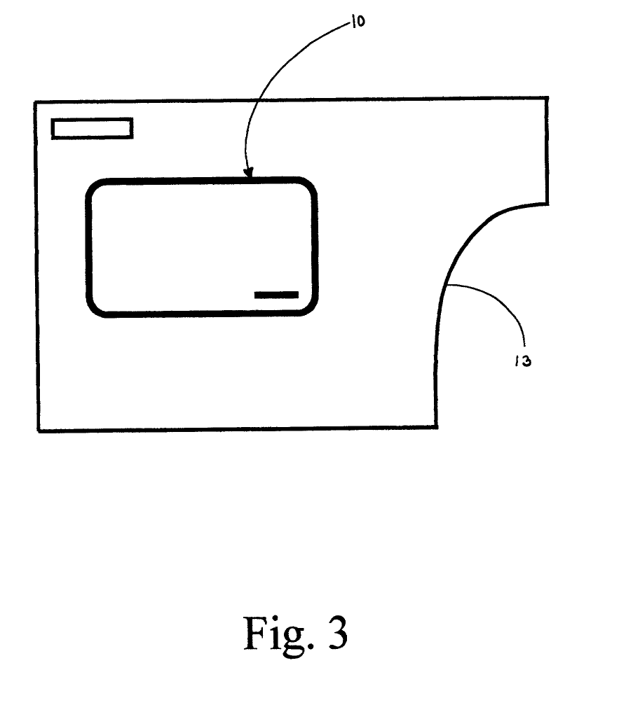

In use as illustrated in FIG. 3, at least one removable protective covering 10 and preferably a total of two or four removable protective coverings, depending upon the number of vehicle doors, are stored inside a vehicle, such as for example in a vehicle trunk or other suitable vehicle storage compartment. Upon reaching a desired destination and parking the vehicle, the at least one removable protective covering 10 or total of two or four removable protective coverings are retrieved from inside the vehicle and placed on the vehicle exterior, such as for example upon the vehicle door 13 illustrated in FIG. 3. The at least one removable protective covering 10 is placed on the vehicle door 13 in a position most likely to prevent dents or dings caused by shopping carts or car doors. The at least one removable protective covering 10 remains attached to the vehicle door 13 due to the magnetic backing 12. Consequently, the resilient front portion 11 due to its resilient composition prevents dents or dings by disbursing impacts. After completion of the desired task, the at least one removable protective covering 10 or total of two or four removable protective coverings are removed from the vehicle exterior and replaced within the vehicle for later reuse as described above.

The removable protective covering 10 accordingly prevent dents or dings without diminishing the aesthetic quality of the vehicle exterior because it is not permanently or continuously mounted on the vehicle exterior but instead remains in place only when the vehicle is parked in locations where dents and dings are a concern. Although the foregoing method describes specific multiples of the removable protective covering 10, those of ordinary skill in the art will recognize that the exact number of removable protective coverings required would depend upon the size of the vehicle.

Although the present invention has been described in terms of the foregoing embodiment, such description has been for exemplary purposes only and, as will be apparent to those of ordinary skill in the art, many alternatives, equivalents, and variations of varying degrees will fall within the scope of the present invention. That scope, accordingly, is not to be limited in any respect by the foregoing description; rather, it is defined only by the claims that follow.

I claim:

1. A method of impact protection for vehicle exteriors, comprising:
storing at least one removable protective covering inside a vehicle;
retrieving the at least one removable protective covering from inside the vehicle upon reaching a desired destination and parking the vehicle;
placing the at least one removable protective covering on the vehicle exterior;
removing the at least one removable protective covering from the vehicle exterior after completion of a desired task; and
replacing the at least one removable protective covering inside the vehicle for later reuse.

2. The method according to claim 1, wherein the at least one removable protective covering comprises a resilient front portion joined to a magnetic backing.

3. The method according to claim 2, wherein the at least one removable protective covering remains on the vehicle exterior due to the magnetic backing.

4. The method according to claim 2, wherein the resilient front portion protects against impacts delivered to the vehicle exterior.

5. The method according to claim 1, wherein the at least one removable protective covering is removable to prevent the diminishing of the aesthetic quality of the vehicle exterior.

6. A method of impact protection for vehicle exteriors, comprising:
providing at least one removable protective covering comprising a resilient front portion joined to a magnetic backing;
storing the at least one removable protective covering inside a vehicle;
retrieving the at least one removable protective covering from inside the vehicle upon reaching a desired destination and parking the vehicle;
placing the at least one removable protective covering on the vehicle exterior;
removing the at least one removable protective covering from the vehicle exterior after completion of a desired task; and
replacing the at least one removable protective covering within the vehicle for later reuse.

7. The method according to claim 6, wherein the at least one removable protective covering remains on the vehicle exterior due to the magnetic backing.

8. The method according to claim 6, wherein the resilient front portion protects against impacts delivered to the vehicle exterior.

9. The method according to claim 6, wherein the at least one removable protective covering is removable to prevent the diminishing of the aesthetic quality of the vehicle exterior.
